(19) United States
(12) Patent Application Publication
(10) Pub. No.: US 2012/0120679 A1
(43) Pub. Date: May 17, 2012

(54) BACKLIGHT MODULE, LIGHT GUIDE PLATE THEREOF AND INK THEREOF

(75) Inventors: HSI-HSIN SHIH, Tainan County (TW); HUNG-WEN WANG, Tainan County (TW); CHIN-MING WANG, Tainan County (TW); CHIEN-TSUNG WU, Tainan County (TW); SHAO-MING LEE, Tainan County (TW)

(73) Assignee: CHI LIN TECHNOLOGY CO., LTD., Tainan County (TW)

(21) Appl. No.: 12/947,086

(22) Filed: Nov. 16, 2010

(51) Int. Cl. F21V 8/00; C09D 11/10; G02B 6/10

(52) U.S. Cl. 362/609; 385/129; 523/218; 523/219

(57) ABSTRACT

The present invention relates to a light guide plate and ink thereof. The ink includes a base resin and a plurality of hollow structures. The hollow structures are dispersed in the base resin and comprise air therein. In the present invention, the hollow structures in the ink give the light guide plate higher light extraction efficiency.

### BACKGROUND OF THE INVENTION

1. Field of the Invention

The present invention relates to a backlight module, light guide plate thereof and ink thereof, and more particularly to an ink having hollow structures, and backlight module and light guide plate including the same.

2. Description of the Related Art

FIG. 1 shows a schematic view of a conventional backlight module. The backlight module 1 includes a light source 11, a reflector 12, a light guide plate 13 and a diffusion film 16. The light source 11, for example, a plurality of LEDs or CCFLs, is used to provide a light beam. The reflector 12 is disposed below the light guide plate 13, and is used to reflect part of the light beam back to the light guide plate 13.

The light guide plate 13 is used to receive and mix the light beam from the light source 11. The light guide plate 13 includes a light guide plate body 14 and an ink 15. The light guide plate body 14 has a first surface 141, a second surface 142 and a side surface 143. The first surface 141 is opposite the second surface 142, and the side surface 143 is adjacent to the first surface 141 and the second surface 142. The light source 11 faces the side surface 143, so that the light beam enters the light guide plate body 14 through the side surface 143 and is then transmitted to the diffusion film 16 through the second surface 142. The material of the light guide plate body 14 is transparent polymer, for example, polymethyl methacrylate (PMMA) or polycarbonate (PC). The ink 15 is printed on the first surface 141 of the light guide plate body 14 to form a pattern, so as to reflect the light beam back to the interior of the light guide plate body 14.

FIG. 2 shows an enlarged cross-sectional view of the ink in FIG. 1. The ink 15 includes a base resin 151, a plurality of fillers 152, and an additive (not shown). The material of the base resin 151 is epoxy resin, polyester resin, acrylic resin, polyvinyl resin, polyamide resin or polyurethane resin. The material of the fillers 152 is inorganic, for example, silica.

Since the fillers 152 are inorganic, the diffusion and reflection effects of the ink 15 are poor. Therefore, the light extraction efficiency of the backlight module 1 measured from a surface of a panel 17 above the diffusion film 16 (FIG. 1) is low.

In addition, during the manufacture process of the ink 15, the base resin 151, the fillers 152, a solvent (not shown), the additive and the curing agent (not shown) are mixed at high speed in a stirring machine, a triple tumbling mill, a sand grinder and a ball mill. During such process, bubbles will be generated in the ink 15. The bubbles will affect the appearance of the ink 15 after printing, thus also affecting the stability of the printing process. Therefore, the ink 15 must further undergoes a debubbling process. The debubbling process is usually performed by vacuum or pressurized filter. Usually, a filter is used in the debubbling process to filter the impurities. The additional debubbling process makes the manufacture process of the ink 15 more complicated. It is understood that the solvent and the curing agent do not exist in the final product of the ink 15.

Therefore, it is necessary to provide a light guide plate and ink thereof to solve the above problems.

### SUMMARY OF THE INVENTION

The present invention is directed to an ink, which comprises a base resin and a plurality of hollow structures. The hollow structures are dispersed in the base resin and comprise air therein.

The present invention is further directed to a light guide plate, which comprises a light guide plate body and an ink. The light guide plate body has a first surface. The ink is disposed on the first surface of the light guide plate body. The ink comprises a base resin and a plurality of hollow structures. The hollow structures are dispersed in the base resin and comprise air therein.

The present invention is further directed to a backlight module, which comprises a light source, a light guide plate, a reflector and a diffusion film. The light source is used for providing a light beam. The light guide plate is used for receiving and mixing the light beam from the light source. The light guide plate body has a first surface and a second surface. The ink is disposed on the first surface of the light guide plate body. The ink comprises a base resin and a plurality of hollow structures. The hollow structures are dispersed in the base resin and comprise air therein. The reflector is disposed below the light guide plate, and is used to reflect part of the light beam back to the light guide plate. The diffusion film is disposed above or on the light guide plate, and is used to diffuse the light beam from the second surface of the light guide plate body.

In the present invention, the hollow structures in the ink give the light guide plate higher light extraction efficiency.

### BRIEF DESCRIPTION OF THE DRAWINGS

FIG. 1 is a schematic view of a conventional backlight module;

FIG. 2 is an enlarged cross-sectional view of the ink in FIG. 1;

FIG. 3 is a schematic view of a backlight module according to a first embodiment of the present invention;

FIG. 4 is an enlarged cross-sectional view of the ink in FIG. 3;

FIG. 5 is an enlarged cross-sectional view of an ink according to a second embodiment of the present invention; and

FIG. 6 is an enlarged cross-sectional view of an ink according to a third embodiment of the present invention.

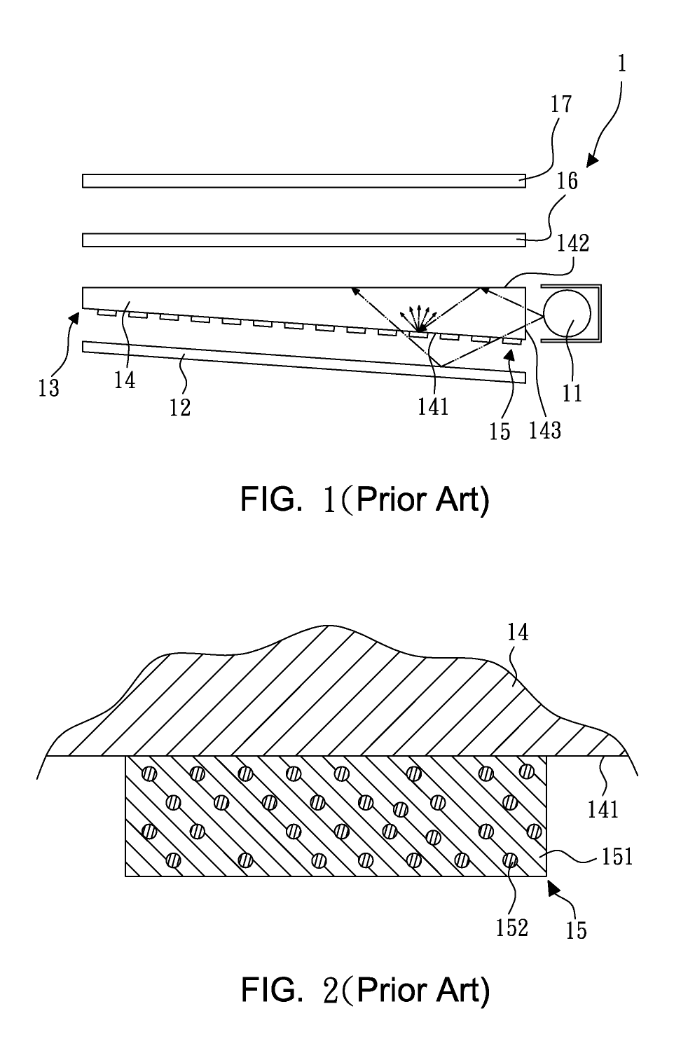

### DETAILED DESCRIPTION OF THE INVENTION

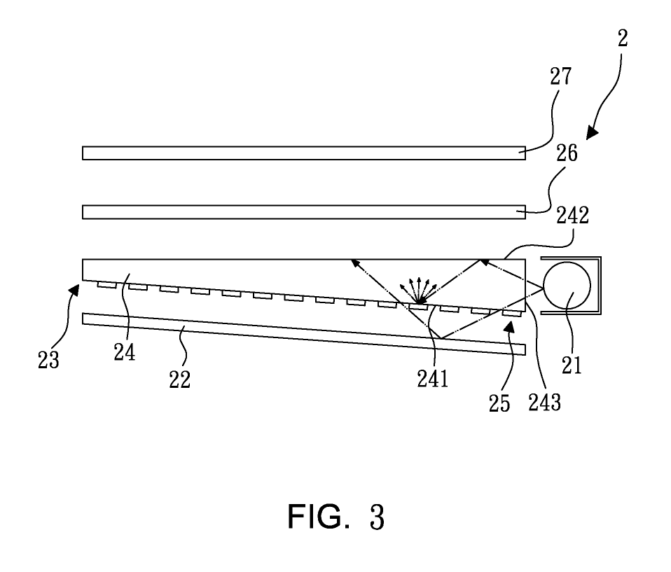

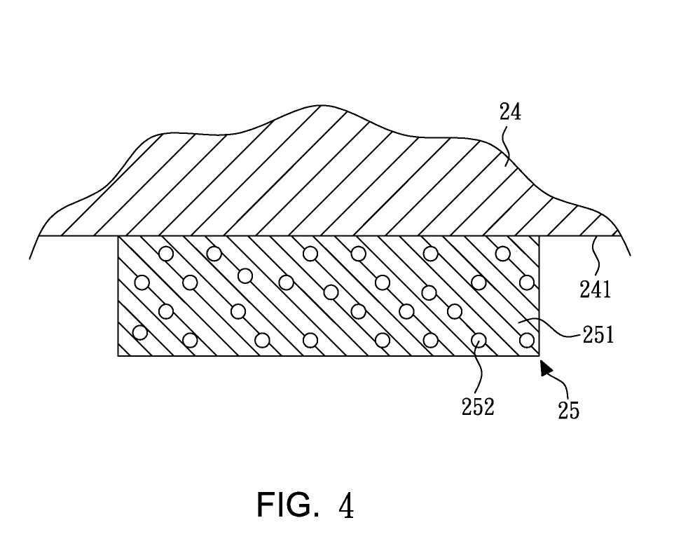

FIG. 3 shows a schematic view of a backlight module according to a first embodiment of the present invention. The backlight module 2 is an edge-lighting backlight module, which comprises a light source 21, a reflector 22, a light guide plate 23 and a diffusion film 26. The light source 21, for example, a plurality of LEDs or CCFLs or a combination thereof, is used to provide a light beam. The reflector 22 is disposed below the light guide plate 23, and is used to reflect part of the light beam back to the light guide plate 23.

The light guide plate 23 is used to receive and mix the light beam from the light source 21. The light guide plate 23 comprises a light guide plate body 24 and an ink 25. The light guide plate body 24 has a first surface 241, a second surface 242 and a side surface 243. The first surface 241 is opposite the second surface 242, and the side surface 243 is adjacent to the first surface 241 and the second surface 242. The light source 21 faces the side surface 243, so that the light beam enters the light guide plate body 24 through the side surface 243 and is then transmitted to the diffusion film 26 through the second surface 242. The material of the light guide plate body 24 is transparent polymer, preferably polymethyl methacrylate (PMMA), arcylic-based polymer, polycarbonate (PC), polyethylene terephthalate (PET) or polystyrene (PS) or a copolymer thereof.

The ink 25 is disposed on the first surface 241 of the light guide plate body 24 to form a pattern, so as to destroy the total reflection of the light beam and reflect the light beam back to the interior of the light guide plate body 24. Preferably, the ink 25 is printed on the first surface 241.

FIG. 4 shows an enlarged cross-sectional view of the ink in FIG. 3. The ink 25 comprises a base resin 251, a plurality of hollow structures 252, and an additive (not shown). The base resin 251 comprises at least one selected from the group consisting of epoxy resin, polyester resin, acrylic resin, polyvinyl resin, polyamide resin, polyurethane resin, a copolymer thereof and a combination thereof. The base resin 251 has a first refractive index. In the embodiment, the hollow structures are bubbles 252. The additive can be an antifoaming agent, a leveling agent or a thixotropic agent, according to the need.

The hollow structures (bubbles 252) comprise air therein. The hollow structures (bubbles 252) have a second refractive index and are dispersed in the base resin 251. The first refractive index is greater than the second refractive index. Preferably, the hollow structures (bubbles 252) are substantially spherical or globular, and the diameter of each of the hollow structures (bubbles 252) is 5 μm to 50 μm.

The methods of forming the bubbles 252 include but are not limited to the following two methods. First, during the manufacture process of the ink 25, if the ink 25 does not undergo a debubbling process, the bubbles 252 generated in the mixing process will be maintained. Second, the bubbles 252 are produced by injecting air, oxygen, or nitrogen into the ink 25.

The diffusion film 26 is disposed above or on the light guide plate 23, and is used to diffuse the light beam from the second surface 242 of the light guide plate body 24.

Table 1 below shows the maximum color difference and color temperature difference in the CIE 1931 color space, and the average brightness and the central brightness measured at nine points on the surface of a panel 17, 27 above the diffusion film 16, 26 by a color analyzers (model: CA-210). The xₘₐₓ is the maximum chromaticity among the points in the CIE 1931 color space, and the xₘₘ is the minimum chromaticity among the points in the CIE 1931 color space. The yₘₐₓ is the maximum chromaticity among the points in the CIE 1931 color space, and the yₘᵢₙ is the minimum chromaticity among the points in the CIE 1931 color space. The average brightness is the average brightness of the nine points. The central brightness is the brightness of the central point.

TABLE 1
comparison of the optical effects of ink 15 (after debubbling)
of prior art and ink 25 (without debubbling) of the present
invention, the model of the ink 15 of prior art and the ink
25 of the present invention both being UV ink J9904C.

| | Δx | Δy | ΔT | average | central |
|---|---|---|---|---|---|
| | (xₘₐₓ − | (yₘₐₓ − | (Tₘₐₓ − | brightness | brightness |
| Ink | xₘᵢₙ) | yₘᵢₙ) | Tₘᵢₙ) (K) | (cd/m²) | (cd/m²) |
| Prior art | 0.0036 | 0.0085 | 1500 | 390 | 419 |
| (after | | | | | |
| debubbling) | | | | | |
| Present | 0.0046 | 0.0093 | 1700 | 403 | 445 |
| invention | | | | | |
| (without | | | | | |
| debubbling) | | | | | |

Compared with conventional ink 15, the ink 25 of the present invention causes higher average brightness and central brightness on the surface of the panel 27. Thus, the ink 25 of the present invention has higher light extraction efficiency. In addition, since the debubbling process is omitted, the manufacture process of the ink 25 of the present invention is simplized. Therefore, the manufacture cost of the ink 25 of the present invention is lower than that of the ink 15 of prior art.

In the embodiment, the ink 25 is disposed on the first surface 241 of the light guide plate body 24. However, it is understood that the ink 25 may be further disposed on the second surface 242 of the light guide plate body 24. That is, the ink 25 may be disposed on one side or both sides of the light guide plate body 24.

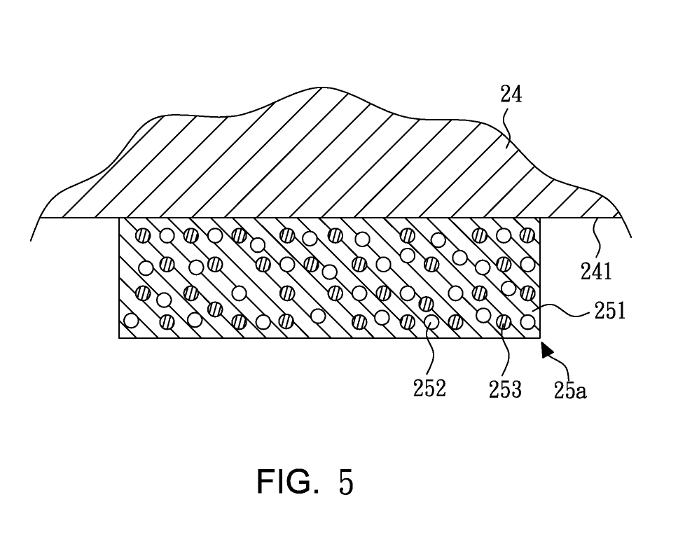

FIG. 5 shows an enlarged cross-sectional view of an ink according to a second embodiment of the present invention. The ink 25a of this embodiment is substantially the same as the ink 25 (FIG. 4) of the first embodiment, and the same numerals are assigned to the same elements. The difference between the ink 25a of this embodiment and the ink 25 of the first embodiment lies in that, in this embodiment, the ink 25a further comprises a plurality of fillers 253 dispersed in the base resin 251. The material of the fillers 253 is silica, epoxy, polyester (PES), polymethyl methacrylate (PMMA), arcylic-based polymer, polyvinyl, polyamide (PA), polyurethane (PU), polystyrene (PS), or a combination thereof. The use of the fillers 253 will lower the color difference and the variation of color temperature of the light guide plate 23.

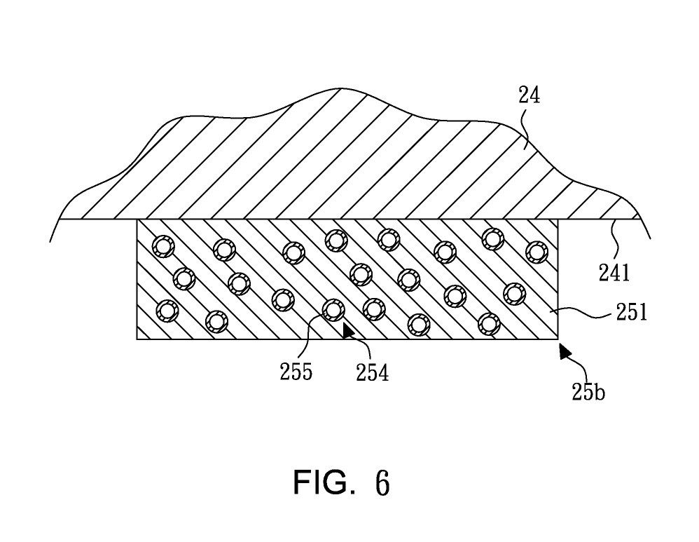

FIG. 6 shows an enlarged cross-sectional view of an ink according to a third embodiment of the present invention. The ink 25b of this embodiment is substantially the same as the ink 25 (FIG. 4) of the first embodiment, and the same numerals are assigned to the same elements. The difference between the ink 25b of this embodiment and the ink 25 of the first embodiment lies in that, in this embodiment, the hollow structures 254 of the ink 25b comprises a hard shell 255 for accommodating the air, and the material of the hard shell 255 is glass or organic. Preferably, the hollow structures 254 are substantially spherical or globular, and the diameter of each of the hollow structures 254 is 5 μm to 50 μm.

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope defined in the appended claims.

What is claimed is:

1. An ink comprising:
a base resin; and
a plurality of hollow structures, dispersed in the base resin, wherein the hollow structures comprise air therein.

2. The ink as claimed in claim 1, wherein the base resin comprises at least one selected from the group consisting of epoxy resin, polyester resin, acrylic resin, polyvinyl resin, polyamide resin, polyurethane resin, a copolymer thereof and a combination thereof.

3. The ink as claimed in claim 1, wherein the hollow structures are bubbles.

4. The ink as claimed in claim 1, wherein each of the hollow structures comprises a hard shell for accommodating the air, and the material of the hard shell is glass or organic.

5. The ink as claimed in claim 1, wherein the hollow structures are substantially spherical or globular.

6. The ink as claimed in claim 1, wherein the diameter of each of the hollow structures is 5 μm to 50 μm.

7. The ink as claimed in claim 1, wherein the base resin has a first refractive index, the hollow structures have a second refractive index, and the first refractive index is greater than the second refractive index.

8. The ink as claimed in claim 1, further comprising a plurality of fillers dispersed in the base resin.

9. The ink as claimed in claim 8, wherein the material of the fillers is silica, epoxy, polyester (PES), polymethyl methacrylate (PMMA), arcylic-based polymer, polyvinyl, polyamide (PA), polyurethane (PU), polystyrene (PS) or a combination thereof.

10. A light guide plate comprising:
a light guide plate body, having a first surface; and
an ink disposed on the first surface of the light guide plate body, the ink comprising:
a base resin; and
a plurality of hollow structures, dispersed in the base resin, wherein the hollow structures comprise air therein.

11. The light guide plate as claimed in claim 10, wherein the base resin comprises at least one selected from the group consisting of epoxy resin, polyester resin, acrylic resin, polyvinyl resin, polyamide resin, polyurethane resin, a copolymer thereof and a combination thereof.

12. The light guide plate as claimed in claim 10, wherein the hollow structures are bubbles.

13. The light guide plate as claimed in claim 10, wherein each of the hollow structures comprises a hard shell for accommodating the air, and the material of the hard shell is glass or organic.

14. The light guide plate as claimed in claim 10, wherein the hollow structures are substantially spherical or globular.

15. The light guide plate as claimed in claim 10, wherein the diameter of each of the hollow structures is 5 μm to 50 μm.

16. The light guide plate as claimed in claim 10, wherein the base resin has a first refractive index, the hollow structures have a second refractive index, and the first refractive index is greater than the second refractive index.

17. The light guide plate as claimed in claim 10, wherein the ink further comprises a plurality of fillers dispersed in the base resin.

18. The light guide plate as claimed in claim 17, wherein the material of the fillers is silica, epoxy, polyester (PES), polymethyl methacrylate (PMMA), arcylic-based polymer, polyvinyl, polyamide (PA), polyurethane (PU), polystyrene (PS) or a combination thereof.

19. A backlight module comprising:
a light source, for provide a light beam;
a light guide plate, for receiving and mixing the light beam from the light source, the light guide plate comprising:
a light guide plate body, having a first surface and a second surface; and
an ink disposed on the first surface of the light guide plate body, the ink comprising:
a base resin; and
a plurality of hollow structures, dispersed in the base resin, wherein the hollow structures comprise air therein;
a reflector, disposed below the light guide plate, and being used to reflect part of the light beam back to the light guide plate; and
a diffusion film, disposed above or on the light guide plate, and being used to diffuse the light beam from the second surface of the light guide plate body.

20. The backlight module as claimed in claim 19, wherein the hollow structures are bubbles.

21. The backlight module as claimed in claim 19, wherein each of the hollow structures comprises a hard shell for accommodating the air, and the material of the hard shell is glass or organic.
